(19) United States
(12) Patent Application Publication
(10) Pub. No.: US 2009/0262974 A1
(43) Pub. Date: Oct. 22, 2009

(54) System and method for obtaining georeferenced mapping data

(76) Inventor: Erik Lithopoulos, Stouffville (CA)

Correspondence Address: COOPER & DUNHAM, LLP, 30 Rockefeller Plaza, 20th Floor, NEW YORK, NY, 10112, US

(21) Appl. No.: 12/386,478

(22) Filed: Apr. 17, 2009

Related U.S. Application Data
(60) Provisional application No. 61/124,722, filed on Apr. 18, 2008.

(51) Int. Cl. G06K 9/00; G01C 3/00

(52) U.S. Cl. 382/100; 356/3; 342/357.06

(57) ABSTRACT

A system and method for acquiring spatial mapping information of surface data points defining a region unable to receive effective GPS signals, such as the interior of a building, includes an IMU for dynamically determining geographical positions relative to at least one fixed reference point, a LIDAR or camera for determining range of the IMU to each surface data point, and a processor to determine position data for each surface data point relative to the at least one reference point. A digital camera obtains characteristic image data, including color data, of the surface data points, and the processor correlates the position data and image data for the surface data points to create an image of the region.

The present application is based upon and hereby claims the benefit of the filing date of prior-filed U.S. provisional application No. 61/124,722, filed Apr. 18, 2008.

### FIELD OF THE INVENTION

The subject matter of the present application relates to obtaining georeferenced mapping data for a target structure or premises in absolute geographical coordinates, and in particular although not limited to, an aided-inertial based mapping system for mapping any region or structure where GPS signals are unavailable or insufficient for an accurate determination of position and location. An indoor mapping instrument is capable of generating indoor maps, for example, that are highly accurate and can be produced quickly by using the instrument while simply walking through the interior areas of the building.

### BACKGROUND OF THE INVENTION

Maps enhance the value of positioning by effectively converting position information of natural and man-made objects, persons, vehicles and structures to location information. Outdoor mapping such as street mapping capability has been announced by companies Navteq and Tele-Atlas. These outdoor location services are GPS-based in that they acquire and use GPS signals to obtain precise position and location information for positioning and mapping. One example is discussed in U.S. Pat. No. 6,711,475. This patent, as well the other patents identified or described herein, are incorporated herein by reference.

Where GPS signals are not available or not dependable (such as indoors) attempts have been made to determine position or location. U.S. Pat. No. 5,959,575 describes the use of a plurality of ground transceivers which transmit pseudo-random signals to be used by a mobile GPS receiver indoors.

In mining operations where GPS signals are not available, U.S. Pat. No. 6,009,359 describes the use of an Inertial Navigation System (INS) to determine position, and obtaining image frames which are tiled together to get a picture of inside the mine. U.S. Pat. No. 6,349,249 describes a system for obtaining mine Tunnel Outline Plan views (TOPES) using an inertial measurement unit (IMU). U.S. Pat. No. 6,608,913 describes a system for obtaining point cloud data of the interior of a mine using an INS, to thereafter locate a position of a mining vehicle in the mine.

In indoor facilities such as buildings, U.S. Pat. No. 7,302,359 describes the use of an IMU and rangefinder to obtain a two-dimensional map of the building interior, such as wall and door locations. U.S. Pat. No. 6,917,893 describes another indoor mapping system for obtaining two-dimensional or three-dimensional data using an IMU, laser rangefinder and camera.

None of these patents appear to disclose obtaining three-dimensional data in a GPS-denied zone such as indoors, wherein the data includes not only three-dimensional position information, but also characteristic image data information, such as color, brightness, reflectivity and texture of the target surfaces to enable an image display of a virtual tour of an interior region as if the person were actually inside the premises.

Sensor technologies that will not only operate indoors but will do it without relying on building infrastructure provide highly desirable advantages for public safety crews, such as firefighters, law enforcement including SWAT teams, and the military. The need for such indoor mapping has increased due to the ever increasing concern to protect the public from terrorist activity especially since terrorist attacks on public, non-military targets where citizens work and live. In addition to terrorist activity, hostage activity and shootings involving student campuses, schools, banks, government buildings, as well as criminal activity such as burglaries and other crimes against people and property have increased the need for such indoor mapping capability and the resulting creation of displayable information that provides avirtual travel through interior regions of a building structure.

What is needed is a system and method for accurate three dimensional mapping of regions, especially those regions where GPS signal information is not available or is unreliable such as within a building structure, and for showing the location and boundaries of interior objects and structures, as well as characteristic image data such as color, reflectivity, brightness, texture, lighting, shading and other features of such structures, whereby such data may be processed and displayed to enable a virtual tour of the mapped region. In particular, a mobile system and method are needed capable of generating indoor maps that are highly accurate and can be produced quickly by simply walking through the interior areas of a building structure to obtain the data needed to create the maps without the use of support from any external infrastructure or the need to exit the indoor space for additional data collection. In addition, a system and method are needed for providing such indoor location information based upon the operator's floor, room and last door walked through, which information can be provided by combining position information with an indoor building map. Moreover, a mobile mapping system and method are need by which high-rate, high-accuracy sensor, position and orientation data are used to geo-reference data from mobile platforms. A benefit from geo-referencing data from a mobile platform is increased productivity since large amounts of map data may be collected over a short period of time.

### SUMMARY OF THE INVENTION

A system and method for acquiring spatial mapping information of surface data points defining a region unable to receive effective GPS signals, such as the interior of a building structure, includes an IMU for dynamically determining geographical positions relative to at least one fixed reference point, a LIDAR or camera for determining a range of the IMU to each surface data point, and a processor to determine position data for each surface data point relative to the at least one reference point. A digital camera obtains characteristic image data, including color data, of each surface data point, and the processor correlates the position data and image data for the surface data points to create an image of the region. Aerial or ground-vehicle based views of the exterior of a building structure containing the region are seamlessly combined to provide indoor and outdoor views.

A system and method are disclosed for acquiring geospatial data information, comprising a positioning device for determining the position of surface data points of a structure in three-dimensions in a region unable to receive adequate GPS signals, an image capture device for obtaining characteristic image data of the surface data points, and a data store device for storing information representing the position and characteristic image data of the surface data points, and for correlating the position and image data for the data points.

A system and method are disclosed for acquiring spatial mapping information, comprising an indoor mapping system (IMS) for determining the position of surface data points of building structure in three-dimensions in a region unable to receive adequate GPS signals. The IMS comprises an IMU for determining position data relative to at least one reference point, and a light detection and ranging (LIDAR) sensor for determining the distance between the IMU and a plurality of surface data points on the building structure, an image capture device for obtaining characteristic image data of the surface data points, a data processor including a data store device for storing information representing the positions of the surface data points and the characteristic image data of the surface data points, and for correlating the position data and image data for the surface data points.

A system and method is disclosed for acquiring spatial mapping information comprising an IMS device for determining the position of surface data points of building structure in three-dimensions in a region unable to receive adequate GPS signals, the IMS device comprising an IMU for determining position data relative to at least one reference point, and a LIDAR sensor for determining the distance between the IMU and surface data points on the building structure. A GPS receiver may be used in a GPS active area for obtaining the position of at least one initial reference point which may be used as a starting reference point by the IMU. The IMS further includes a digital camera for obtaining characteristic image data of the surface data points, the image data including color data, and a processor and data store device by which digital information representing the positions of surface data points and the characteristic image data of the surface data points is stored and correlated. The processor recreates for display an image of the building structure using the position data and image data.

In an embodiment, an IMS is based on a navigation-grade IMU aided by zero-velocity updates. The IMU is combined with a scanning laser and a digital camera. The system is small and lightweight and can be backpack portable. The aided-inertial system measures the IMS position as well as pitch, roll, heading and the laser measures the distance between the IMS and the laser data points. Combining these measurements provides a detailed map of the details of the surveyed regions of the building. This can be further visually enhanced by combining digital cameral imagery with the laser data points. The resulting photomaps are geo-referenced digital imagery of the surveyed regions, and can be detailed at sub-meter accuracies.

By providing information to enable a virtual tour of the interior premises, a roving person such as a law enforcement officer or military person can be equipped with a display device, which may be near the eyes, such as a head-up display or a stereo display device, and can walk through the premises and have a virtual tour even if there is no light or if the premises is filled with smoke or the like. The person can be directed by other personnel outside the premises who can be equipped with the same display of the same images observed by the rover to enable such personnel to communicate with and guide the person inside the premises. This can minimize the number of personnel at risk. Alternatively, a robot can be used, guided by outside personnel, which could be maneuvered throughout a desired region of the premises without placing a person at risk.

### BRIEF DESCRIPTION OF THE DRAWINGS

For a further understanding of the subject matter described herein, reference may be had to the accompanying drawings in which:

FIG. 1 is a block diagram of an embodiment of the invention;

FIG. 2A is a diagram of a stick figure carrying a data acquisition system according to an embodiment of the invention;

FIG. 2B is a perspective view of the components of the system of FIG. 2A;

FIG. 2C is a perspective view of a mobile push cart data acquisition system according to an embodiment of the invention;

FIG. 3 is a flowchart of steps involved in acquiring mapping data according to an embodiment of the invention;

FIG. 4 is a vector diagram illustrating a georeferencing concept according to an embodiment of the invention;

FIG. 5A describes a one-time procedure to calibrate the distances and angles, the so called lever arms, from the LIDAR and camera to the IMU; and

FIG. 5B illustrates the steps necessary to produce a map from the collected data, obtaining position, orientation, LIDAR and camera data.

### DETAILED DESCRIPTION OF A PREFERRED EMBODIMENT

### Definitions

As used herein, the term “geospatial data” means image and position data for points in space.

As used herein, the term “georeferencing” means the assigning of geographical coordinates to one or more points in space.

As used herein, the term “mobile mapping” means the collection of georeferenced data from a mobile platform, such as a person, or a land vehicle.

As used herein, the term “image data” means information which characterizes the visual attributes of a structure or object, other than location or position, such as color, reflectivity, brightness, texture, lighting and/or shading for example.

As used herein, the term “building structure” means walls, partitions, or other structure which define the interior space a building, such as a commercial building, residence building or the like.

As used herein, the term “position” means the geographical coordinates of longitude, latitude and altitude of an object or thing, such as a point.

As used herein, the term “location” means the relative position of an object or thing, such as a point, as defined by its surroundings, such as the floor and room in an indoor structure.

### DESCRIPTION

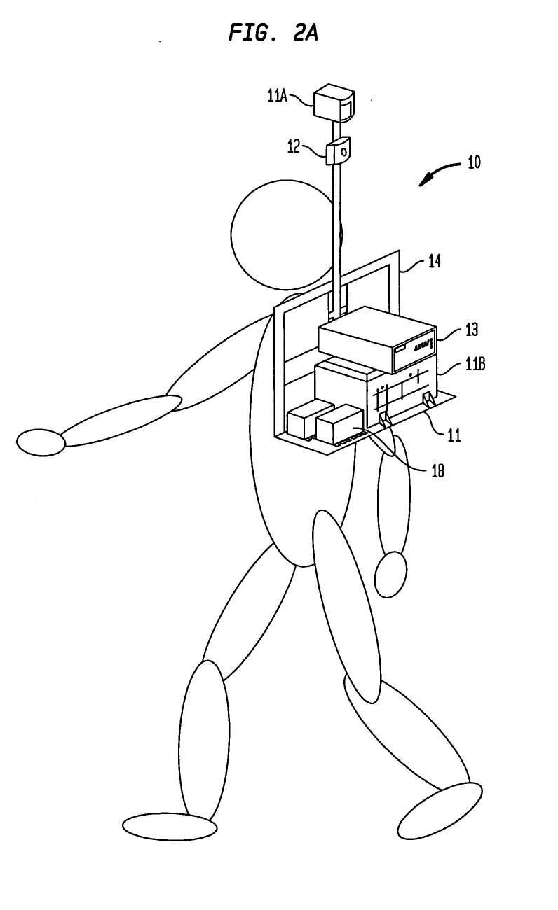

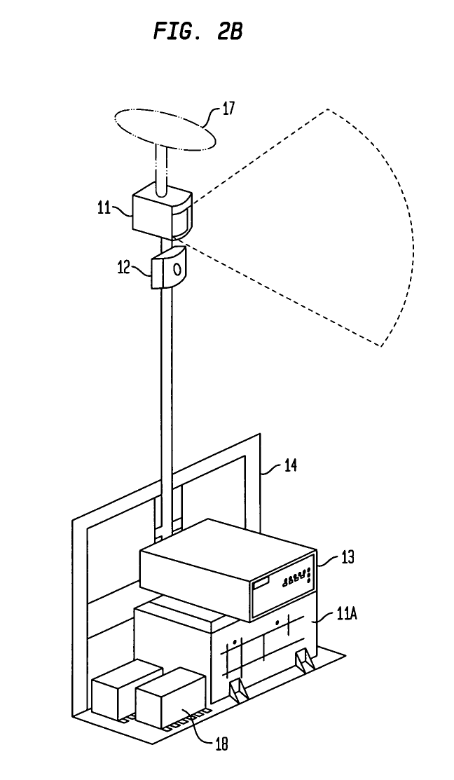

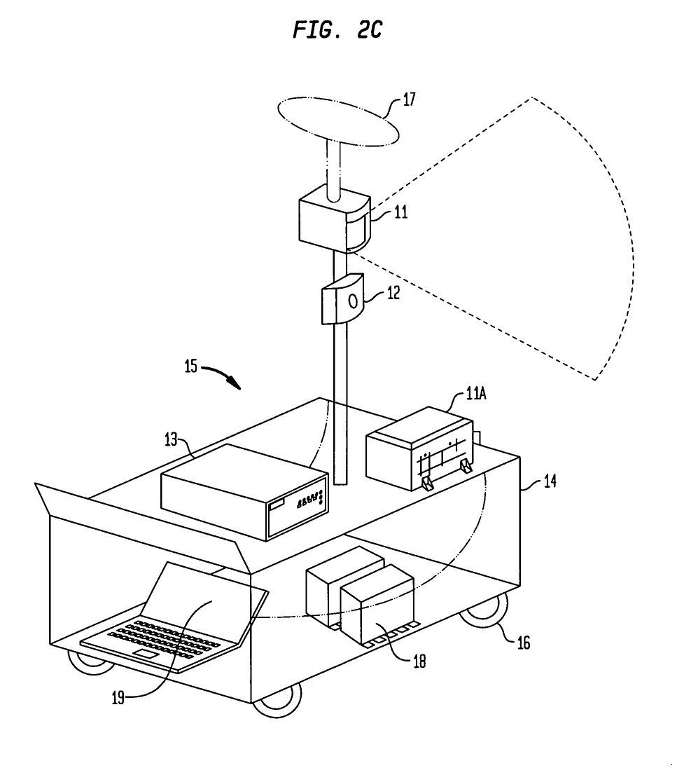

With reference to FIGS. 2A-2C, a system and method for acquiring geospatial data information for mapping includes a mobile IMS, generally indicated by reference numeral 10. The IMS consists of a sensor platform 11, which may include a LIDAR sensor 11A. The LIDAR sensor 11A is a scanning laser for obtaining ranging information relative to a plurality of surface data points of a target structure in a region unable to receive adequate GPS signals. The LIDAR sensor 11A transmits laser pulses to target surface points and records the time it takes for each reflected pulse to return to the sensor receiver, thereby enabling a distance determination between the sensor 11A and the target points. The sensor platform 11 includes an image capture device 12, which may be a digital camera, for obtaining characteristic image data of the surface data points, and a digital system processor and data storage device 13 for storing information representing the position and characteristic image data of the surface data points. The processor correlates the position and image data for the data points. The correlation of the position and image data by the processor enables the recreation of an image of a target structure based upon the positions of the surface data points and the characteristic image data thereof.

The sensor platform 11 may also include an IMU 11B for determining positions within the GPS inactive region relative to at least one reference point. The IMU 11B is functionally integrated with the LIDAR 11A and the camera 12 for enabling the determination of the position of each of a plurality of surface data points on the target structure relative to the reference point. The LIDAR 11A, the IMU 11B and the image capture device 12 may be mounted on a common frame backpack type of frame 14. As depicted in FIG. 2A, the frame 14 may be adapted as a back pack to be carried by a person. In this way, the IMU may be moved through a GPS inactive region and measure its position along the way. An advantage of a backpack portable frame is that any area accessible by a human can be mapped with the use of the sensor platform. The LIDAR, camera and IMU are firmly mounted onto the frame in order to maintain the distance offsets between them unchanged. These offsets are accurately calibrated once during installation and their values are stored in the data storage system.

With reference to FIG. 2C, the frame 14 may have wheels 16 to form a mobile cart, generally indicated by reference numeral 15. A cart, as opposed to a framed backpack 14, can carry a larger and heavier LIDAR with longer range and additional batteries 18 to power it. The batteries may be Lithium Ion. Further, and due to the fact that the IMU experiences less vibration on a cart, the positioning performance of a cart-based sensor platform is slightly better than that of a backpack.

In some circumstances, the sensor platform may further include a GPS receiver forming part of a smart antenna 17, shown in dotted lines in FIGS. 2B and 2C, for obtaining the position of at least one initial reference point where GPS signals are available. Such a reference point may be used as a starting reference point by the IMU 11B. The characteristic image data from a camera may include color data in digital format sent to the digital data storage and processor 13. Batteries 18 appropriately power the sensor platform.

The system processor 13 receives ranging, imaging and position data from the LIDAR 11A, the camera 12 and the IMU 11B, respectively. A data store retains position data and image data for use by the processor to correlate the stored position data and image data for each of the surface data points. This is accomplished by assigning the geographical coordinates to geospatial data so that the image date is correlated with position data. In this way the processor 13 is able to create an image of the target structure or region from a perspective different from the location of the positioning capability. As an example, when a target region is the interior of a building structure, the processor may create on a display 19 (FIG. 2C) images of the interior building structure which images can be panned to depict on the display 19 views from different horizontal and vertical positions. The processor may produce a three-dimensional image of the target structure or region which can be zoomed in and out. Existing aerial or ground-vehicle images of the exterior of the same structure may be combined with the images of the interior of the building.

The positioning data and digital image data can be used to create photomaps of all visible surfaces or objects and structures in an interior building space. The in-building photomaps are accurately georeferenced. This means that every image pixel in the collected imagery has accurate geographical coordinates assigned to it. The resulting photomaps are georeferenced digital imagery of a building's interior detail at decimeter-level accuracies. This level of accuracy may be necessary in order to determine the exact location of operators within the building and, as an example, quickly and effectively guide rescue missions in law enforcement or military operations.

Outside photomaps of the building can be collected from a land vehicle and/or aircraft or helicopter. The collection of outdoor photomaps may be done by integrating GPS position information with data obtained from LIDAR sensors and digital cameras, as described above. When GPS is available, it is not necessary to employ navigation-grade IMU sensors to establish positions, as is necessary for indoor mapping operations. A seamless blending of indoor building photomaps with other indoor photomaps, as well as with outdoor photomaps, enables the creation of a complete inside-outside view of an entire building.

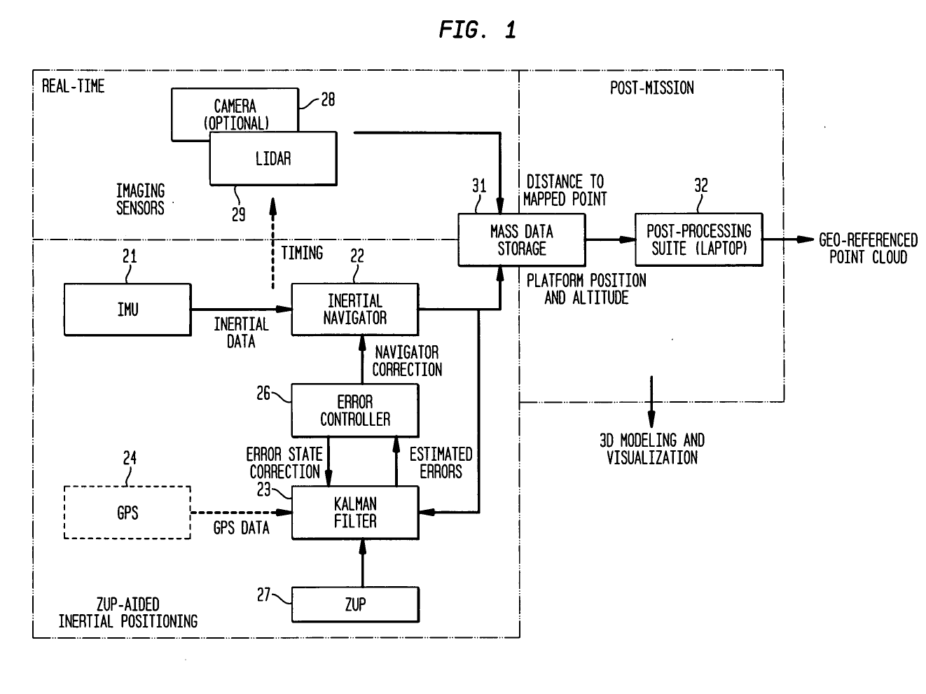

With reference to FIG. 1, there is shown a block diagram of the components of an embodiment of an IMS. FIG. 1 is divided into four sections. The lower left section of FIG. 1 depicts in block format inertial measurement components including an IMU at block 21 functionally connected to an Inertial Navigator at block 22. This block depicts a ZUP-aided inertial IMU, which measures sensor position and orientation. Blocks containing error correction components described below present position correction information to the Inertial Navigator. The error correction components are important because the accuracy of the IMU position measurements degrades with distance traveled.

The IMU at block 21 represents a highly precise, navigation-grade IMU having various components, including three gyroscope and three accelerometer sensors that provide incremental linear and angular motion measurements to the Inertial Navigator. The IMU may be high-performance, navigation-grade, using gyroscopes with 0.01 deg/hr performance or better, such as the Honeywell HG9900, HG2120 or micro IRS. The Inertial Navigator, using sensor error estimates provided by a Kalman filter at block 23, corrects these initial measurements and transforms them to estimates of the x, y, z position, and orientation data including pitch, roll and heading data for the backpack or cart, at a selected navigation frame. When GPS signals are available, a GPS receiver, shown at block 24 in dotted lines, provides GPS data to the Kalman Filter for the initial alignment of the IMU only. The alignment process based upon GPS position information may be static or dynamic. If static, it occurs at a fixed and known position with known coordinates. It may also be accomplished on a moving vehicle using GPS to aid in obtaining correct position information from the IMU.

For continued operation in an interior region of a building subsequent navigation is performed in the complete absence of GPS. In such a case, when the GPS signal is lost, the IMU takes over and acquires the position data. The Kalman filter at block 23 provides processed measurement information subject to errors to an error controller at block 26, which keeps track of the accumulated errors in estimated measurements over time. When the Kalman Filter's estimated measurement errors grow above a threshold, usually over a period of from 1 to 2 minutes, the system requests a zero velocity update (ZUP), indicated at block 27, from the operator through an audio notification. The sensor platform 11, either a backpack or cart, is then motionless for 10-15 sec to permit the Kalman filter to perform error corrections for the then existing position of the sensor platform. The mapping operation is resumed after each roughly 15 second delay period. In this situation, the IMU can operate without any GPS aiding for hours, using only ZUP as an aid to correction of the IMU's sensor errors. In this way, the Inertial Navigator obtains updated correct position information every few minutes, a technique that avoids the otherwise regular degradation in accuracy for IMU position measurements over time.

The upper left section of FIG. 1 depicts the imaging sensors described above. This section depicts a geospatial data sensor such as a LIDAR at block 29, a camera at block 28, or both, by which geospatial data is collected. The digital camera at block 28 captures image data such as color, brightness and other visual attributes from surface structures or objects being mapped inside the target building or structure. The LIDAR at block 29 measures how far and in what direction (pitch, roll and heading) the target structure or object being imaged is located from the sensor platform, to provide relative displacement information. The LIDAR sensor, a scanning laser, may be a SICK, Riegl or Velodyne sensor. In an embodiment, a single camera may be used without a LIDAR, in which case depth may be determined from sequential views of the same feature. The camera may be a Point Grey camera. In an embodiment comprising a stereo pair system, depth may be determined from a single view of a feature (or features). If a camera is used to determine depth or distance instead of a LIDAR, then the post-mission software may perform the function of range determination.

All data, including the LIDAR and image data, as well as the IMU incremental x, y, z position and pitch, roll and heading information are stored on a mass storage device at block 31, depicted in the upper right section of FIG. 1. This section depicts a post-processor which improves position/orientation accuracy (which is optional), and which georeferences the collected geospatial data. The input data is time-tagged with time provided by an internal clock in the system processor or computer and is stored in a mass storage device at block 31 such as a computer hard drive. The computer system may be an Applanix POS Computer System.

The data is retrieved post-mission through a post processing suite at block 32 which combines the aided-inertial system's position and orientation measurements with the LIDAR's range measurements. Post-mission software performs two-functions. One function is to combine pitch/roll/heading with the range measurements to build a three dimensional geo-referenced point cloud of the traversed space. The lower right section of FIG. 1 depicts production of three dimensional modeling and visualization for use by others to view the completed indoor map.

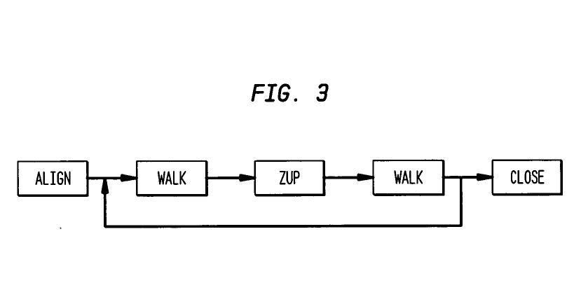

With reference to FIG. 3, there is depicted a flowchart of an embodiment in which the steps involved in acquiring mapping data are illustrated. The first step “Align” includes determining north and down directions either statically or dynamically. Statically means at a fixed position with known coordinates, typically on the ground using GPS, which may take about 10-20 minutes. Dynamically means on a vehicle or a person moving using GPS-aiding.

The next step “Walk” involves any walking speed or movement of the data acquisition/collection apparatus through the premises being mapped. The person has a LIDAR and digital camera to acquire depth and image data, as described above.

The next step “ZUP” involves obtaining a zero-velocity update of position by, for example, stopping every 1-2 minutes and standing motionless for 10-15 seconds in order to permit correction of the measured position information. The step “Walk” is then continued until the next ZUP period. The steps of Walk and ZUP are repeated until mapping of the target region is complete.

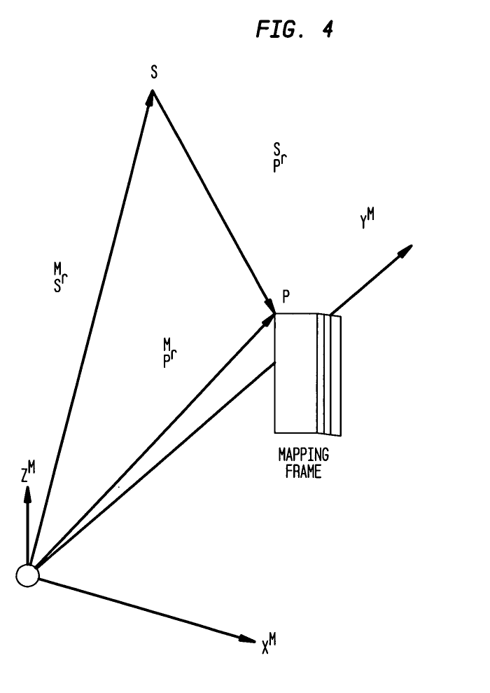

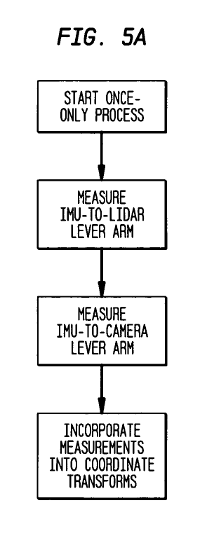

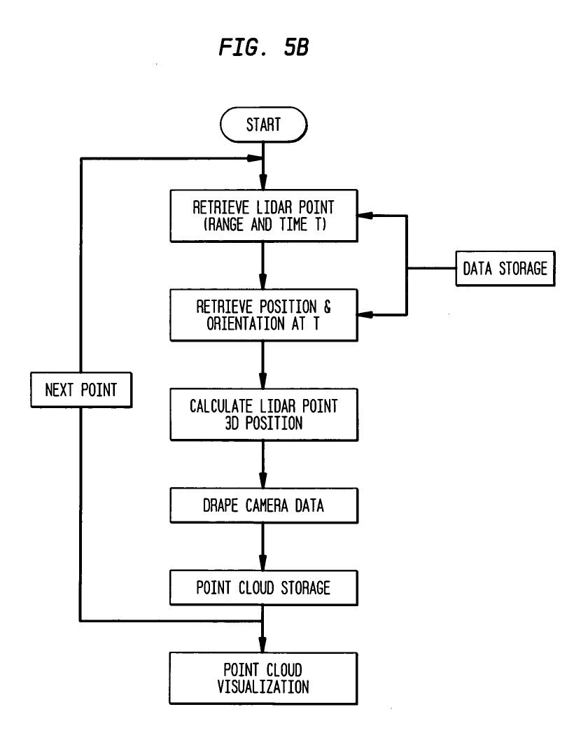

With reference to FIGS. 4, 5A and 5B, there is depicted an embodiment of a georeferencing process or method for acquiring spatial mapping information, i.e., assigning mapping frame coordinates to a target point P on a structure to be mapped using measurements taken by a remote sensor. A general method consists of determining the positions of a plurality of surface data points P of a target structure, obtaining characteristic image data of the surface data points, storing information representing the positions of the surface data points of the target structure along with their characteristic image date, and correlating the position data and image data for the surface data points. The method may further include the step of recreating, for purposes of display, an image of the target structure using the positioning data and image data.

FIG. 4 is a vector diagram illustrating the a method of deriving mapping frame coordinates for a target point P on a surface to be mapped based upon measurements made by a remote sensor platform S. The sensor platform S consists of the instrument cluster shown in FIGS. 2A-2C. The vector rₛ^{M} represents the Cartesian coordinates of a sensor platform S relative to a fixed reference point M. The vector rₚ^{s} is the sensor pointing vector representing attitude data for the sensor platform S relative to the target point P, as well as the distance from the sensor platform S to the target point P. The vector rₚ^{M} is a vector representing the position of a mapped point P relative to the reference point M.

The first step in the process is to determine the vector rₛ^{M}. In outdoor environments this can be accomplished by using GPS or a GPS-aided inertial system. In an indoor environment this can be accomplished by using a ZUP-aided IMU. The next step is to determine the vector rₚ^{s} by determining the polar coordinates of the sensor platform S (attitude angles: roll, pitch, heading) and the distance of the sensor platform S from the point P. The angles may be determined using gyroscopes and a ZUP-aided IMU. In an embodiment, the ZUP-aided IMU is a navigation-grade IMU. The distance from the position sensor to the point P may be determined using a laser scanning device such as the LIDAR described above, or by using a stereo camera pair and triangulating. A single camera may also be used for obtaining sequentially spaced images of the target point from which distance from the position sensor to the target point P may be derived. As indicated above, the camera also provides characteristic image data for each target point P on the surface to be mapped. The information available from the foregoing vectors enables the computation of the coordinates of the target point P.

FIGS. 5A and 5B illustrate the implementation of a georeferencing process. In FIG. 5A a one-time procedure of lever arm calibration is illustrated. The IMU, LIDAR and camera are firmly mounted on the rigid frame 14 or cart 15 (the sensor platform, FIGS. 2A-2C). The distance between and relative orientations of the IMU, LIDAR and camera are thereby fixed and are measured and stored in the data store 31 (FIG. 1) of the processor 13. This will permit the position and orientation measurements taking place at each point in time at the IMU to be correlated to the relative position and orientation of the camera and of the LIDAR at that time to aid in coordinate transforms.

FIG. 5B outlines the steps to implement the georeferencing process as illustrated and described in connection with FIG. 4. LIDAR range measurement of each target surface point P and the time T it was obtained are retrieved from data storage and correlated with the IMU determination of position and orientation at the time T. Three dimensional geographical coordinates of each point P may then be calculated and stored. Image data of the point P from a camera may be draped over the LIDAR data for point P to provide and store texture and color for that point. This process is continued from point to point thereby forming a cloud of stored georeferenced positions in three dimensions for each mapped point P on the surface to be mapped.

When the image data is correlated with the stored point position data, a data base exists by which the processor can reconstruct an image of a mapped interior surface area of the premises by selecting a vantage point, and selecting an azimuth and direction from that vantage point from which to display an image defined by the stored three dimensional positions for each mapped point on the surface area being mapped. These may be visualized using a suite such as the one from Object Raku. The processor will recreate or reconstruct an image representing the actual interior of the premises as though the viewer were actually inside the premises looking through an image capture device. The image seen can be continuously changed by selecting different vantage points as though the viewer was traveling through the premises, and the azimuth and direction may also be changed, either when the vantage point is constant or changing. The processor may also create stereo images, with an image provided separately to each eye of a viewer, to provide a three dimensional image. The images may be displayed on left and right displays worn as eyewear. Such an arrangement provides a virtual reality tour of the inside of the premises without actually being present inside the premises. The image or images viewed may be panned horizontally or vertically, or zoomed in or out.

While various exemplary embodiments of a georeferencing system and method have been shown and described, the described embodiments do not limit scope of protection afforded by the appended claims. It will be understood by those skilled in the art that various changes in form and details may be made without departing from the scope of the appended claims, which alone constitute the sole measure of the scope of protection for the subject matter shown, described and claimed herein.

What is claimed is:

1. A system for acquiring geospatial data information, comprising:
a positioning device for determining the position of surface data points of a structure in three-dimensions in a region unable to receive adequate GPS signals;
an image capture device for obtaining characteristic image data of the surface data points;
a data store device for storing information representing the position and characteristic image data of the surface data points, and for correlating the position and image data for the data points.

2. The system of claim 1, further comprising a processor for recreating an image of the building structure using the position data and image data.

3. The system of claim 1, wherein the position device comprises an Inertial Measurement Unit (IMU).

4. The system of claim 1, wherein the position device comprises a LIDAR.

5. The system of claim 1, wherein the position device comprises an IMU for determining the position of at least one reference point, and a LIDAR for determining the positions of at least some surface data points relative to the reference point.

6. The system of claim 1, wherein the image capture device comprises a digital camera.

7. The system of claim 1, wherein the position device comprises a LIDAR and the image capture device comprises a digital camera.

8. The system of claim 1, wherein the position device and image capture device are mounted on a common frame.

9. The system of claim 8, wherein the frame is adapted to be carried by a person.

10. The system of claim 8, wherein the frame has wheels to form a mobile cart.

11. The system of claim 3, further including a GPS receiver for obtaining position of an initial reference point which is used by the IMU.

12. The system of claim 1, wherein the characteristic image data includes color data.

13. The system of claim 2, wherein the processor recreates an image of the building structure from a perspective different from the location of the position device.

14. The system of claim 13, wherein the processor recreates an image of the building structure which can be panned to different horizontal and vertical positions.

15. The system of claim 13, wherein the processor recreates an image which can be zoomed in and out.

16. A system for acquiring spatial mapping information, comprising:
an IMU for dynamically determining geographical position data relative to at least one fixed reference point;
a range scanning device for obtaining distance data representative of the distance from said IMU to each of a plurality of surface data points, each of said plurality of surface data points defining a region unable to receive effective GPS signals;
an image capture device to provide characteristic image data for each of said plurality of surface data points;
a data store for all of said data; and
a data processor to determine position information for each of said plurality of surface data points and to correlate the position data and characteristic image data for each of said surface data points to create an image of the region.

17. The system of claim 16, in which said region is the interior of a building and the processor creates an image of the building interior using the position data and characteristic image data.

18. The system of claim 16, wherein the image capture device comprises a digital camera.

19. The system of claim 16, wherein the IMU and image capture device are mounted on a common frame.

20. The system of claim 19, wherein the frame is adapted to be carried by a person.

21. The system of claim 19, wherein the frame has wheels to form a mobile cart.

22. The system of claim 16, further including a GPS receiver for obtaining the position of said at least one fixed reference point.

23. The system of claim 16, wherein the characteristic image data includes color data.

24. The system of claim 17, wherein the processor creates an image of the building from a perspective different from the position of the IMU.

25. The system of claim 17, wherein the processor creates an image of the building which can be panned to different horizontal and vertical positions.

26. The system of claim 17, wherein the processor creates an image of the building which can be zoomed in and out.

27. A system for acquiring spatial mapping information, comprising:
A sensor platform for determining the position of surface data points of building structure in three-dimensions in a region unable to receive adequate GPS signals, the sensor platform comprising an IMU for determining the position of at least one reference point, and a LIDAR for determining the positions of the surface data points relative to the reference point, and further including a GPS receiver for obtaining position of at least one initial reference point which is used as a starting reference point by the IMU;
a digital camera for obtaining characteristic image data of the surface data points, said image data including color data;
a processor and data store device for receiving and storing information representing the position of surface data points and the characteristic image data of the surface data points, and for correlating the position data and image data for the data points, said processor recreating an image of the building structure using the position data and image data.

28. The system of claim 27, wherein the position device and image capture device are mounted on a common frame.

29. The system of claim 28, wherein the frame is adapted to be carried by a person.

30. The system of claim 28, wherein the frame has wheels to form a mobile cart.

31. The system of claim 27, wherein the processor recreates an image of the building structure from a perspective different from the location of the position device.

32. The system of claim 27, wherein the processor recreates an image of the building structure which can be panned to different horizontal and vertical positions.

33. A method for acquiring spatial mapping information, comprising:
determining the position of surface data points of building structure in three-dimensions in a region unable to receive adequate GPS signals;
obtaining characteristic image data of the surface data points; and
storing information representing the position of surface data points and the characteristic image data of the surface data points, wherein the position data and image data for the data points are correlated.

34. The method of claim 33, further including the step of recreating an image of the building structure using the position data and image data.

35. The method of claim 33, wherein the step of determining the position of surface data points comprises using an inertial measurement unit (IMU) determining the position of at least one reference point, and a LIDAR for determining the positions of at least some surface data points relative to the reference point.

36. The method of claim 33, wherein the step of obtaining characteristic image data comprises using a digital camera.

37. The method of claim 33, wherein the steps of determining the position of surface data points and obtaining characteristic image data of the surface data points comprise using a common frame to which is mounted a device for determining the position of the surface data points and a device for obtaining characteristic image data.

38. The method of claim 37, wherein the common frame is adapted to be carried by a person.

39. The method of claim 37, wherein the common frame is mounted on wheels.

40. The method of claim 33, wherein the step of obtaining the position of surface data points comprises using a GPS receiver for obtaining position of an initial reference point which is used by the IMU.

41. The method of claim 33, wherein the characteristic image data includes color data.

42. The method of claim 33, further including the step of recreating an image of the building structure from a perspective different from the location of the position device.

43. The method of claim 33, further including the step of recreating an image of the building structure which can be panned to different horizontal and vertical positions.

44. The method of claim 33, further including the step of recreating an image which can be zoomed in and out.

45. The system of claim 16 in which said region is the interior of a building.

46. The system of claim 45 comprising aerial or ground-based images of the exterior of said building combined with said image of said region.

47. The system of claim 16 in which said IMU is adapted to traverse through said region.

48. The system of claim 47 in which said fixed reference point is within a GPS active location and its position is determined based upon GPS signals.

49. The system of claim 48 in which said fixed reference point is a starting point for said IMU.
